(19) United States
(12) Patent Application Publication
(10) Pub. No.: US 2012/0001364 A1
(43) Pub. Date: Jan. 5, 2012

(54) Injection Molding Apparatus

(75) Inventors: Yong Seung Shin, Hwaseong-si (KR); Ki Yul Lim, Suwon-si (KR); Geun Ho Lee, Yongin-si (KR); Young Soo Lee, Hwaseong-si (KR)

(73) Assignee: SAMSUNG ELECTRONICS CO., LTD., Suwon-si (KR)

(21) Appl. No.: 13/162,944

(22) Filed: Jun. 17, 2011

(30) Foreign Application Priority Data
Jul. 5, 2010 (KR) 10-2010-0064412

(51) Int. Cl. B29C 45/14

(52) U.S. Cl. 264/275; 425/127

(57) ABSTRACT

The injection molding apparatus includes a first mold, a second mold, and a film having a micro pattern. The film contacts an injection molding material injected into a space defined by the first mold and the second mold.

### CROSS-REFERENCE TO RELATED APPLICATION

This application claims priority under 35 U.S.C. §119 to Korean Patent Application No. 2010-0064412, filed on Jul. 5, 2010 in the Korean Intellectual Property Office (KIPO), the entire contents of which is incorporated herein by reference.

### BACKGROUND

1. Field

Example embodiments relate to an injection molding apparatus and/or method that form a pattern on an injection molded product.

2. Description of the Related Art

Recently research has been conducted into processes regarding designing exteriors of products, for example, processes related to forming products with irregular surfaces by carving designs in the surfaces of the products in relief or in intaglio so as to provide a textured feel.

Forming the irregular surfaces of the products may include mechanically forming designs on surfaces of the products, forming designs in molds to form the products such that the products have irregular surfaces, and inserting additional parts having irregular surfaces into molds such that the parts are attached to the products.

Three-dimensional micro shapes may not be obtained using known processes. In addition, productivity may be low.

### SUMMARY

At least one example embodiment provides an injection molding apparatus that forms a micro pattern on a product.

At least one example embodiment provides an injection molding apparatus that forms a three-dimensional micro pattern on a product.

At least one example embodiment provides an injection molding apparatus that forms a micro pattern on a product using a simple structure.

Additional aspects of the invention will be set forth in part in the description which follows and, in part, will be obvious from the description, or may be learned by practice of the invention.

In accordance with at least one example embodiment, an injection molding apparatus includes a first mold, a second mold, and a film having a micro pattern, wherein the film contacts an injection molding material injected into a space defined by the first mold and the second mold.

The injection molding apparatus may further include a film fixing unit to fix the film, wherein the film is around the first mold or the second mold by the film fixing unit. The film may have a cubic shape formed by pressure of the injection molding material injected into the space defined by the first mold and the second mold. The film may be separated from an injection molded product formed by curing the injection molding material.

The film may be in the first mold or the second mold. The film may be separated from the first mold or the second mold in a state in which the film is coupled to one surface of an injection molded product formed by curing the injection molding material. The film may be separated from the injection molded product.

In at least one example embodiment, an injection molding apparatus includes a stationary mold having a depression, a movable mold having a protrusion, and a transfer member having a micro pattern, wherein the transfer member is disposed at the depression of the stationary mold.

The transfer member may contact an injection molding material injected into a cavity defined by the depression and the protrusion. The transfer member may have a cubic shape formed by pressure of the injection molding material injected into the cavity.

The transfer member may be separated from the stationary mold in a state in which the transfer member is coupled to an injection molded product formed by curing the injection molding material. The transfer member may be separated from the injection molded product. The injection molded product may have a micro pattern corresponding to the micro pattern of the transfer member.

In at least one example embodiment, an injection molding apparatus includes a stationary mold, a movable mold, a transfer member having a micro pattern, and a fixing unit to fix the transfer member, wherein the transfer member is disposed between the stationary mold and the movable mold by the fixing unit.

The stationary mold may have a depression, and the movable mold may have a protrusion. The depression and the protrusion may define a cavity, and the transfer member may have a cubic shape formed by pressure of an injection molding material injected into the cavity. The transfer member may be separated from an injection molded product formed by curing the injection molding material injected into the cavity. The injection molded product may have a micro pattern corresponding to the micro pattern of the transfer member.

In at least one example embodiment, an injection molding method includes preparing a film having a micro pattern, disposing the film in or around a mold, injecting an injection molding material into a space defined by the mold and the film, separating an injection molded product formed by curing the injection molding material from the mold, and removing film from the injection molded product. The injection molding method may further include coating a surface of the injection molded product with a protective layer.

### BRIEF DESCRIPTION OF THE DRAWINGS

Example embodiments will be more clearly understood from the following brief description taken in conjunction with the accompanying drawings. FIGS. 1-10 represent non-limiting, example embodiments as described herein.

These and/or other aspects of the invention will become apparent and more readily appreciated from the following description of the embodiments, taken in conjunction with the accompanying drawings of which:

FIG. 1 is a sectional view illustrating an injection molding apparatus according to at least one example embodiment;

FIG. 2 is a sectional view illustrating a state in which a movable mold is moved toward a stationary mold in the injection molding apparatus of FIG. 1;

FIG. 3 is a sectional view illustrating a state in which an injection molding material is introduced into a space between the movable mold and the stationary mold through the movable mold in the injection molding apparatus of FIG. 1;

FIG. 4 is a sectional view illustrating a state in which the injection molding material is cured in the space between the movable mold and the stationary mold in the injection molding apparatus of FIG. 1;

FIG. 5 is a sectional view illustrating a state in which an injection molded product is separated from the movable mold and the stationary mold in the injection molding apparatus of FIG. 1;

FIG. 6 is a sectional view illustrating an injection molding apparatus according to at least one example embodiment;

FIG. 7 is a sectional view illustrating a state in which a movable mold is moved toward a stationary mold in the injection molding apparatus of FIG. 6;

FIG. 8 is a sectional view illustrating a state in which an injection molding material is introduced into a space between the movable mold and the stationary mold through the movable mold in the injection molding apparatus of FIG. 6;

FIG. 9 is a sectional view illustrating a state in which the injection molding material is cured in the space between the movable mold and the stationary mold in the injection molding apparatus of FIG. 6;

FIG. 10 is a sectional view illustrating a state in which an injection molded product and a film attached to the injection molded product are separated from the movable mold and the stationary mold in the injection molding apparatus of FIG. 6; and

FIG. 11 is a sectional view illustrating a state in which the injection molded product manufactured by the injection molding apparatus of FIG. 6 is separated from the film.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments will now be described more fully with reference to the accompanying drawings, in which example embodiments are shown. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Reference will now be made in detail to the embodiments of the present invention, examples of which are illustrated in the accompanying drawings, wherein like reference numerals refer to like elements throughout.

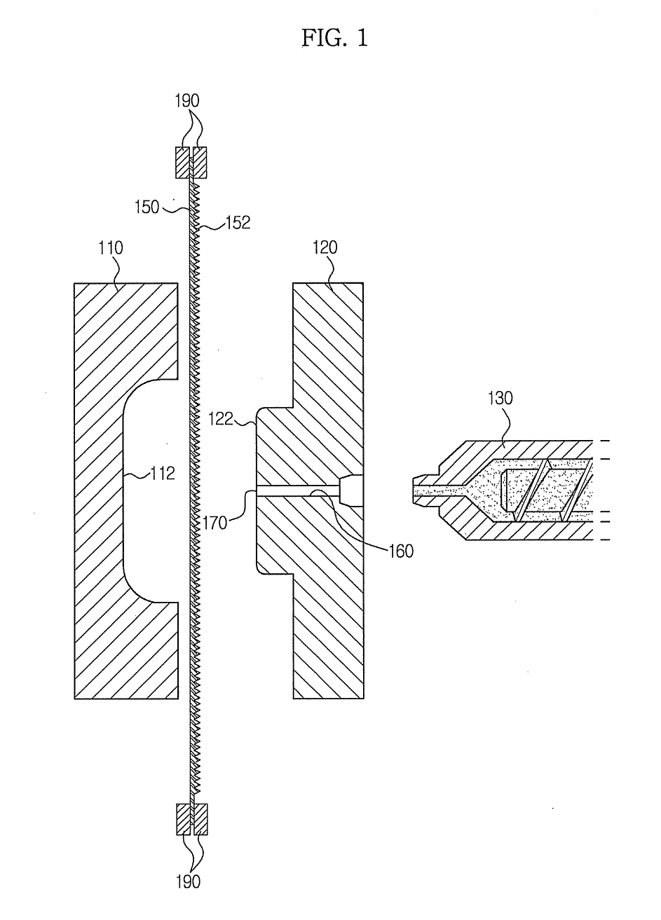

FIG. 1 is a sectional view illustrating an injection molding apparatus according to at least one example embodiment. As shown in FIG. 1, the injection molding apparatus may include a first mold 110, a second mold 120, a screw device 130, a film 150, and a fixing member 190. The first mold 110 may be a stationary mold, which is fixed to a support (not shown) during an injection molding process.

The first mold 110 may have a depression 112, which may define a cavity, into which an injection molding material may be injected, together with a protrusion 122 of the second mold 120, which will be described in more detail below. The second mold 120 may be a movable mold, which may be moved toward or away from the first mold 110 during the injection molding process.

The protrusion 122 of the second mold 120 may be formed in a shape corresponding to the depression 112. As described above, the cavity, into which the injection molding material may be injected, may be defined by the protrusion 122 and the depression 112. The second mold 120 may have a runner 160 and a gate 170.

The runner 160 may be a channel through which an injection molding material supplied by the screw device 130 flows toward the cavity. The gate 170 may be an inlet through which the injection molding material may be supplied into the cavity. The runner 160 may be a hot runner, which keeps the injection molding material at a desired (or, alternatively, a predetermined) temperature for a desired (or, alternatively, a predetermined) period of time during which the injection molding material may be supplied into the cavity.

The film 150 may be on or disposed around the first mold 110 or the second mold 120. The film may be disposed between the first mold 110 and the second mold 120. The film 150 may be made of a material with high elasticity, such as, for example, poly methyl methacrylate (PMMA), polyethylene terephthalate (PET), polycarbonate (PC), or acrylonitrile butadiene styrene (ABS), which may be deformed upon receiving pressure from a fluid. The film 150 may have a micro pattern 152.

The micro pattern 152, which may form a desired (or, alternatively, a predetermined) design on an injection molding material supplied into the cavity, may be an irregular shape provided at one major surface of the film 150. The micro pattern 152 may be formed on the film 150 using, for example, an ultraviolet (UV) transfer process, a pattern molding method or a roller pressing method.

In the UV transfer process, a UV coating liquid may be applied to the rear of a film 150, a panel having a three-dimensional pattern may be firmly attached to one major surface of the film 150, and ultraviolet light may be irradiated to the film 150 such that the UV coating liquid is cured in a state in which a photosensitive film which transmits the ultraviolet light is attached to the other major surface of the film 150 to which the panel is not attached, thereby forming a micro pattern 152 on the film 150.

In the pattern molding process, a coating liquid may be applied to the mold, a film is attached to the coating liquid on the mold in a tight contact manner, the film may be pressed by a roller or a flattening device, the coating liquid may be cured, and the film may be separated from the mold, thereby forming a micro pattern on the film.

In the roller pressing process, a film 150 may be fed by a plurality of feed rollers, the fed film 150 may pass through a space defined between a pattern roller having a pattern and a pressing roller which may press the film 150 against the pattern roller, and the film may be cured using a curing device, thereby forming a micro pattern 152 on the film 150.

The micro pattern 152 may include various figures. For example, electroforming may be used to express a cubic effect or a metal texture, such as, for example, a hologram or a metal sticker. Furthermore, glare, non-glare, hairlines, spin, and etching may be expressed. In addition, all figures having engraving and relief may be expressed.

The film 150 having the micro pattern 152 including such figures may serve as a transfer member to form a figure corresponding to the micro pattern 152 on an injection molded product. That is, the film 150 having the micro pattern 152 may be used as the transfer member.

The film fixing member 190 fixes the film 150 such that the film 150 may be between the first mold 110 and the second mold 120. The film fixing member 190 may fix opposite ends of the film 150.

In at least one example embodiment a material that easily forms the micro pattern 152 and is easily separated from the film after being cured may be used as the injection molding material. For example, cyclic olefin copolymer (COO), poly methyl methacrylate (PMMA), polyethylene terephthalate (PET), polypropylene, polybutylene terephthalate (PBT), polycarbonate (PC), acrylonitrile butadiene styrene (ABS), or polyoxymethylene may be used as the injection molding material.

Hereinafter, a method of forming the micro pattern 152 on an injection molded product using the injection molding apparatus of FIG. 1 will be described.

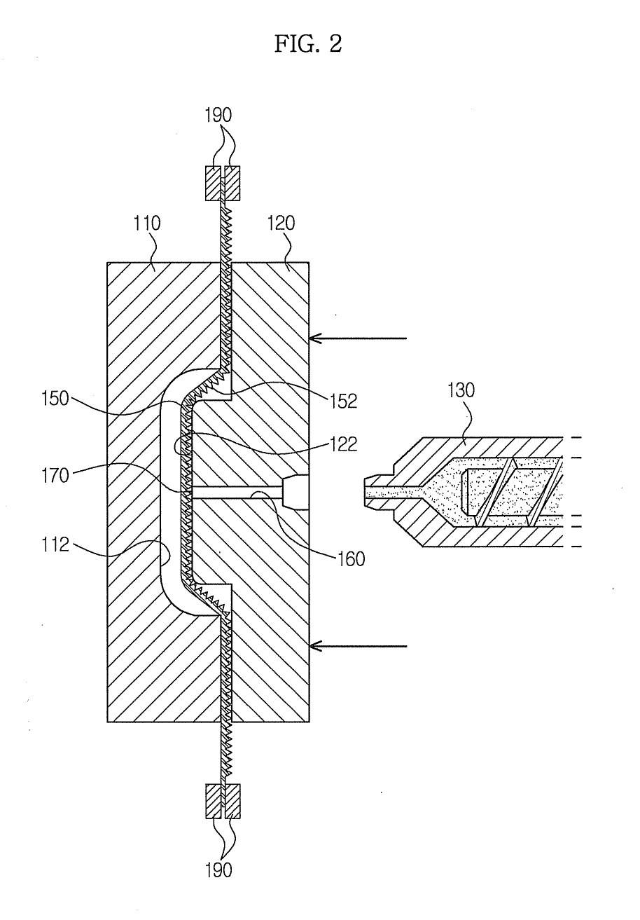

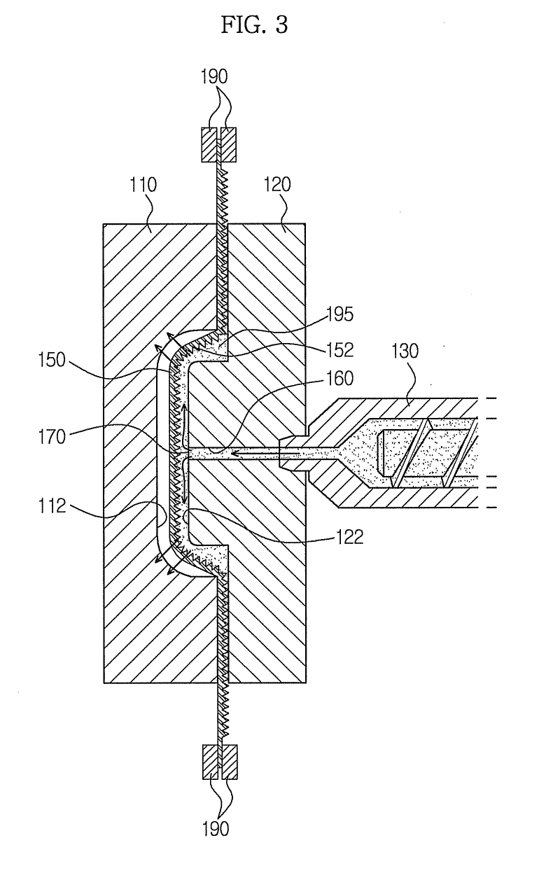

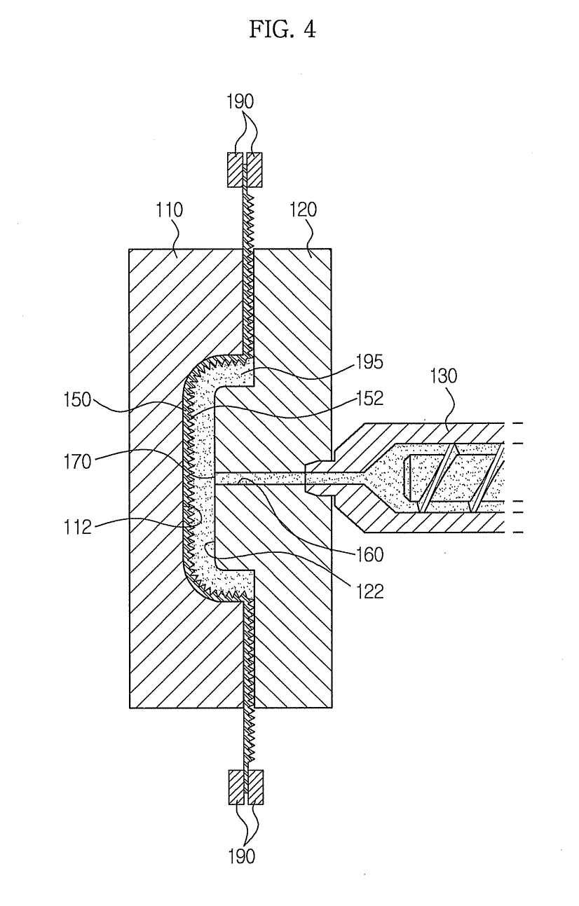

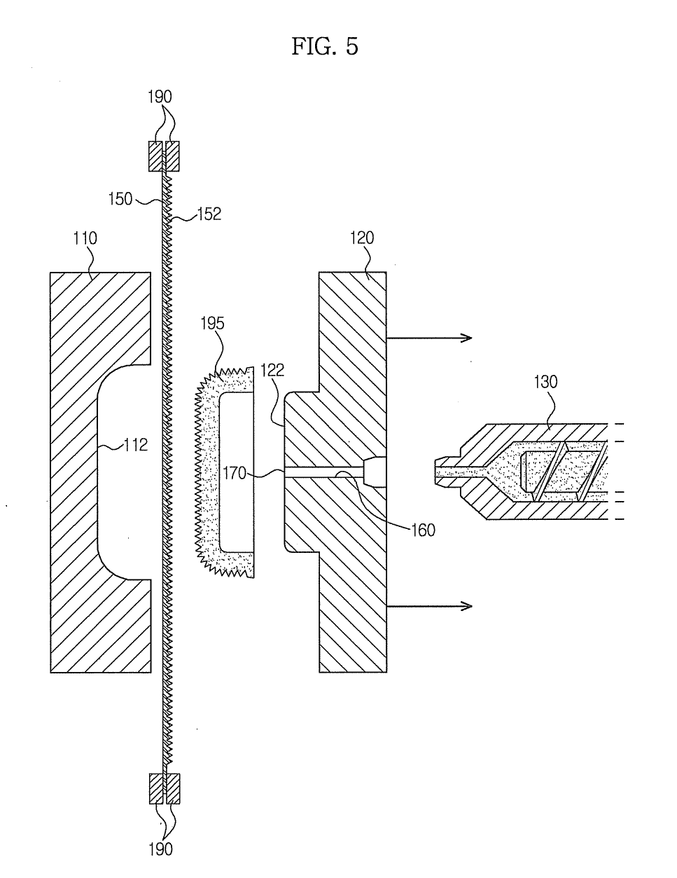

FIG. 2 is a sectional view illustrating a state in which the movable mold is moved toward the stationary mold. FIG. 3 is a sectional view illustrating a state in which an injection molding material is introduced into a space between the movable mold and the stationary mold through the movable mold. FIG. 4 is a sectional view illustrating a state in which the injection molding material is cured in the space between the movable mold and the stationary mold. FIG. 5 is a sectional view illustrating a state in which an injection molded product is separated from the movable mold and the stationary mold.

As shown in FIGS. 1 and 2, the first mold 110 may be fixed to the support (not shown), and the film 150 having the micro pattern 152 may be spaced apart from the first mold 110 by a desired (or, alternatively, a predetermined) distance by the film fixing member 190. The film 150 may be spaced apart from the first mold 110 such that, if the film 150 is elastically deformed by the protrusion 122 of the second mold 120, the deformed portion of the film 150 may be located in the depression 112 of the first mold 110.

The opposite ends of the film 150 may be fixed by the film fixing member 190 such that a two-dimensional planar shape of the film 150 may be maintained. The second mold 120 may be opposite to the first mold 110 in a state in which the film fixing member 190 and the film 150 fixed by the film fixing member 190 are between the first mold 110 and the second mold 120.

If the second mold 120 is moved toward the first mold 110 in this state, the protrusion 122 of the second mold 120 may elastically deform the film 150 toward the first mold 110. The film 150 may be elastically deformed toward the first mold 110 in a state in which the film may be in contact with the protrusion 122. With continuous movement of the second mold 120, the film 150 may enter the depression 112 of the first mold 110.

If the movement of the second mold 120 is completed, a cavity may be defined by the depression 112 and the protrusion 122, and the deformed portion of the film 150 may be located in the depression 112 in a state in which the deformed portion of the film is in contact with the protrusion 122.

If the second mold 120 tightly contacts the first mold 110, as shown in FIG. 3, an injection molding material, supplied from the screw device 130, may flow through the runner 160 and the gate 170 of the second mold 120. After flowing through the gate 170, the injection molding material may flow along the surface of the protrusion 122 from the center to the periphery thereof while pushing the film 150 contacting the protrusion 122 toward the depression 112.

The film 150 may be elastically deformed toward the depression 112 due to pressure of the introduced injection molding material, with the result that the shape of the film may be changed from a two-dimensional planar shape to a three-dimensional cubic shape, and, finally, the film may have a shape corresponding to the cavity. If the introduction of the injection molding material is completed, the cavity may be filled with the injection molding material in a state in which the injection molding material may be in contact with the film 150.

The film 150 may be deformed by the pressure of the introduced injection molding material as described above. During deformation of the film 150, therefore, the film 150 may have a three-dimensional cubic shape with a natural curve. Consequently, the micro pattern 152 of the film 150 may be naturally formed on the curve of an injection molded product 195. The curve of the injection molded product 195 may be a portion where the front and side of the injection molded product 195 join.

As shown in FIGS. 4 and 5, the temperature in the mold assembly may be lowered to cure the injection molding material in the mold assembly, and therefore, the injection molded product 195 may be manufactured. The portion of the injection molded product 195 contacting the film 150 may have a pattern corresponding to the micro pattern 152 of the film 150.

If the second mold 120 is moved away from the first mold 110 in this state, the injection molded product 195 having the micro pattern 152 may be separated from the molds. After being separated from the molds, the injection molded product 195 may be separated from the film 150.

Before injection of the injection molding material, a mold release agent may be applied to the surface of the film 150 having the micro pattern 152 such that the injection molded product 195 may be easily separated from the film 150 when the injection molded product 195 is separated from the molds.

The portion of the injection molded product 195 separated from the film 150 may be coated with a protective layer to prevent the pattern of the injection molded product 195 from being deformed. While the film 150 is separated from the injection molded product 195, the film 150 may be elastically restored, with the result that the film 150 has the two-dimensional planar shape.

The micro pattern 152 may be formed on the back as well as the front of the injection molded product 195 using such elastic deformation of the film 150. Alternatively, the micro pattern 152 may be formed on both the front and the back of the injection molded product 195. Also, the micro pattern 152 may be naturally formed on the portion where the front and side of the injection molded product 195 join.

Hereinafter, an injection molding apparatus according to at least one example embodiment and a method of forming a micro pattern 152 on an injection molded product using the injection molding apparatus will be described.

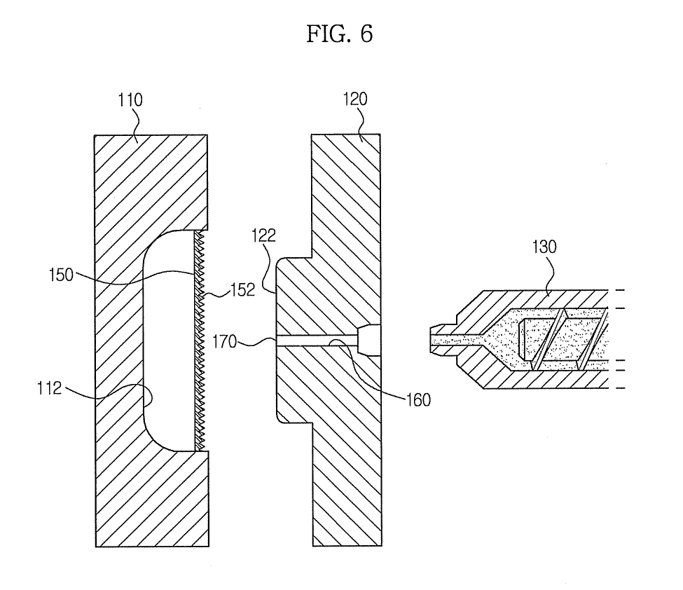

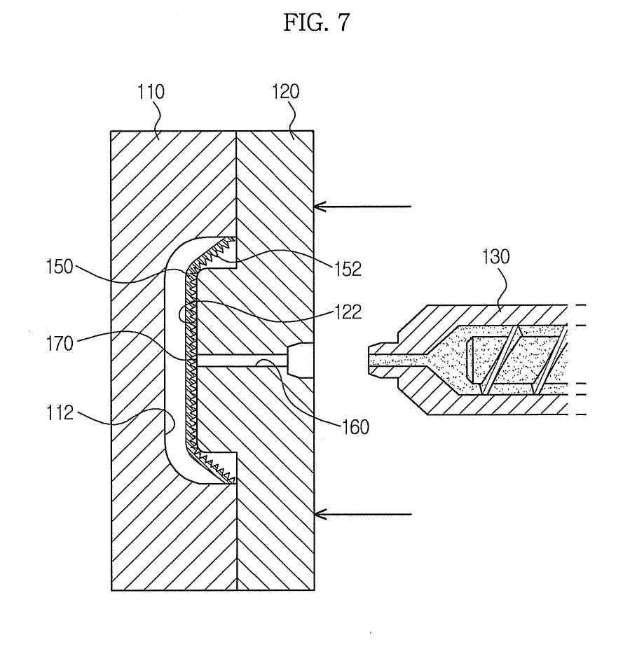

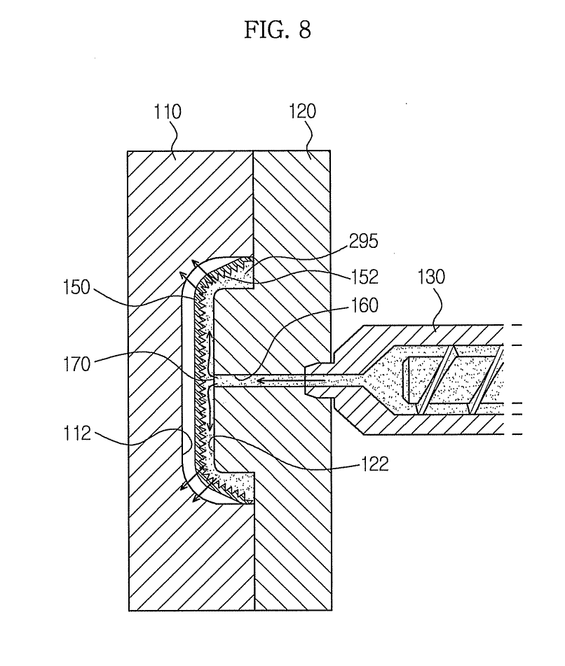

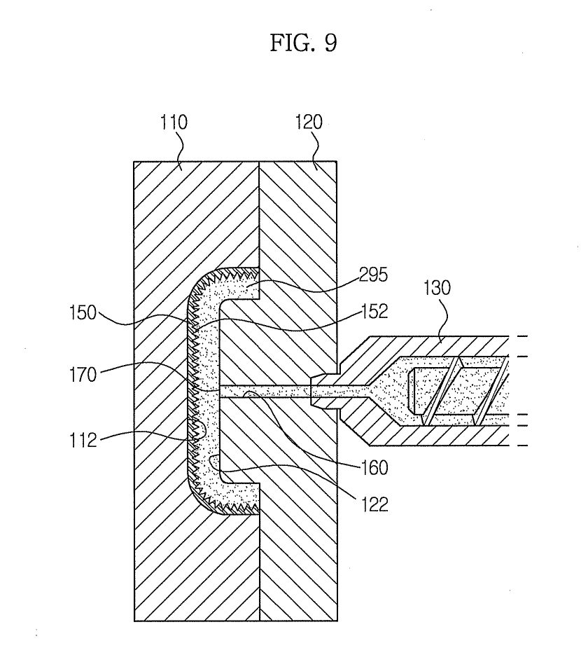

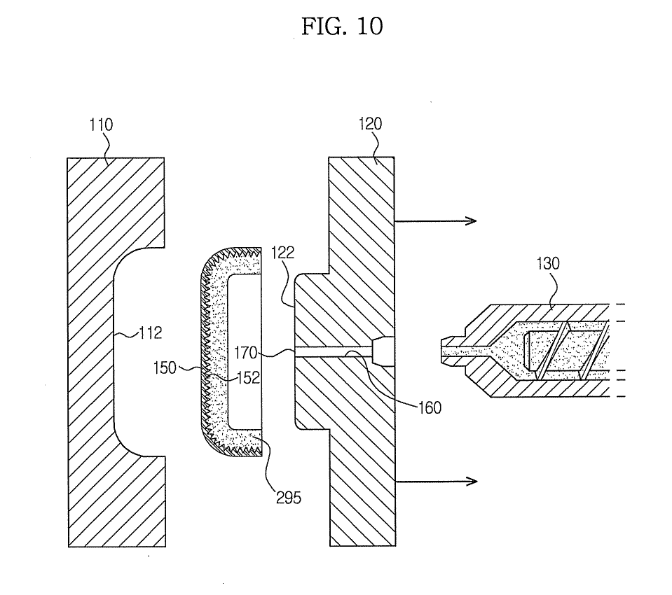

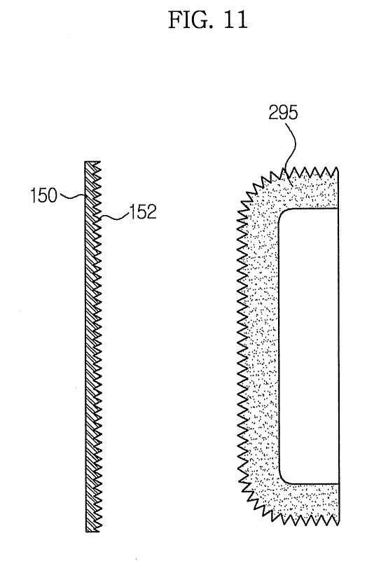

FIG. 6 is a sectional view illustrating an injection molding apparatus according to at least one example embodiment. FIG. 7 is a sectional view illustrating a state in which a movable mold is moved toward a stationary mold. FIG. 8 is a sectional view illustrating a state in which an injection molding material is introduced into a space between the movable mold and the stationary mold through the movable mold. FIG. 9 is a sectional view illustrating a state in which the injection molding material is cured in the space between the movable mold and the stationary mold. FIG. 10 is a sectional view illustrating a state in which an injection molded product and a film attached to the injection molded product are separated from the movable mold and the stationary mold. FIG. 11 is a sectional view illustrating a state in which the manufactured injection molded product is separated from the film.

As shown in FIGS. 6 and 7, the injection molding apparatus may include a first mold 110, a second mold 120, a screw device 130, a film 150, and a fixing member 190.

The first mold 110, the second mold 120, the screw device 130, the film 150, and the fixing member 190 may be identical to those described above, and, for the sake of brevity, a detailed description thereof will not be given. Hereinafter, the difference between this example embodiment and the previous example embodiment will be described. In the injection molding apparatus, the film 150 having the micro pattern 152 may be fixedly disposed at the depression 112 of the first mold 110.

A vacuum chuck (not shown) may be used to fix the film 150 to the depression 112. Alternatively, a bonding agent (not shown) may be applied to the film 150. Opposite ends of the film 150 may be fixed to one side of the depression 112 such that a two-dimensional planar shape of the film 150 may be maintained.

The second mold 120 may be opposite to the first mold 110 such that the film 150 may be between the first mold 110 and the second mold 120. If the second mold 120 is moved toward the first mold 110, the protrusion 122 of the second mold 120 may elastically deform the film 150 toward the depression 112.

If the movement of the second mold 120 is completed, a cavity may be defined by the depression 112 and the protrusion 122, and the deformed portion of the film 150 may contact the protrusion 122. If the second mold 120 tightly contacts the first mold 110, as shown in FIG. 8, an injection molding material, supplied from the screw device 130, may flow through the runner 160 and the gate 170 of the second mold 120.

After flowing through the gate 170, the injection molding material may flow along the surface of the protrusion 122 from the center to the periphery thereof while pushing the film 150 contacting the protrusion 122 toward the depression 112. The film 150 may be elastically deformed toward the depression 112 due to pressure of the introduced injection molding material, with the result that the shape of the film may be changed from a two-dimensional planar shape to a three-dimensional cubic shape, and, finally, the film may have a shape corresponding to the cavity. If the introduction of the injection molding material is completed, the cavity may be filled with the injection molding material such that the injection molding material may be in contact with the film 150.

The film 150 may be deformed by the pressure of the introduced injection molding material as described above. During deformation of the film 150, therefore, the film 150 may have a three-dimensional cubic shape with a natural curve. Consequently, the micro pattern 152 of the film 150 may be naturally formed on the curve of an injection molded product 295. The curve of the injection molded product 295 may be a portion where the front and side of the injection molded product 295 join.

As shown in FIGS. 9 to 11, the temperature in the mold assembly may be lowered to cure the injection molding material in the mold assembly, and therefore, the injection molded product 295 may be manufactured. The portion of the injection molded product 295 contacting the film 150 may have a pattern corresponding to the micro pattern 152 of the film 150.

If the second mold 120 is moved away from the first mold 110, the injection molded product 295 may be separated from the molds such that the injection molded product 295 is coupled to the film 150. Subsequently, the injection molded product 295 may be separated from the film 150, thereby obtaining a product having a desired (or, alternatively, a predetermined) pattern.

Because the micro pattern 152 of the film 150 may be transferred to the injection molded product 295 as described above, micro patterns that are not formed using the molds may be obtained. In addition, various designs may be formed on the injection molded product 295 by simply changing the film 150 having the micro pattern 152 without replacement of the molds. Consequently, the molds may be commonly used.

Although example embodiments have been shown and described, it would be appreciated by those skilled in the art that changes and/or variations in form and detail may be made in these example embodiments without departing from the scope and spirit of the claims.

What is claimed is:

1. An injection molding apparatus comprising:
a first mold and a second mold; and
a film having a micro pattern, the film contacting an injection molding material injected into a space defined by the first mold and the second mold.

2. The injection molding apparatus according to claim 1, further comprising:
a fixing member configured to hold the film around one of the first mold and the second mold.

3. The injection molding apparatus according to claim 2, wherein the film has a cubic shape formed by a pressure associated with the injection molding material as the injection molding material is injected into the space.

4. The injection molding apparatus according to claim 3, wherein the film is separated from an injection molded product formed by curing the injection molding material.

5. The injection molding apparatus according to claim 1, wherein the film is in contact with one of the first mold and the second mold.

6. The injection molding apparatus according to claim 5, wherein the film is separated from one of the first mold and the second mold if the film is coupled to one surface of an injection molded product formed by curing the injection molding material.

7. The injection molding apparatus according to claim 6, wherein the film is separated from the injection molded product.

8. An injection molding apparatus comprising:
a stationary mold having a depression;
a movable mold having a protrusion; and
a transfer member having a micro pattern,
the transfer member being in contact with the depression of the stationary mold.

9. The injection molding apparatus according to claim 8, wherein the transfer member is configured to contact an injection molding material injected into a cavity defined by the depression and the protrusion.

10. The injection molding apparatus according to claim 9, wherein the transfer member has a cubic shape formed by pressure of the injection molding material injected into the cavity.

11. The injection molding apparatus according to claim 10, wherein the transfer member is separated from the stationary mold if the transfer member is coupled to an injection molded product formed by curing the injection molding material.

12. The injection molding apparatus according to claim 11, wherein the transfer member is separated from the injection molded product.

13. The injection molding apparatus according to claim 12, wherein the injection molded product includes a micro pattern corresponding to the micro pattern of the transfer member.

14. An injection molding apparatus comprising:
a stationary mold and a movable mold;
a transfer member having a micro pattern; and
a fixing member configured to hold the transfer member such that
the transfer member is between the stationary mold and the movable mold.

15. The injection molding apparatus according to claim 14, wherein the stationary mold includes a depression, and the movable mold includes a protrusion.

16. The injection molding apparatus according to claim 15, wherein the depression and the protrusion define a cavity, and the transfer member has a cubic shape formed by pressure of an injection molding material injected into the cavity.

17. The injection molding apparatus according to claim 16, wherein the transfer member is separated from an injection molded product formed by curing the injection molding material injected into the cavity.

18. The injection molding apparatus according to claim 17, wherein the injection molded product includes a micro pattern corresponding to the micro pattern of the transfer member.

19. An injection molding method comprising:
generating a film having a micro pattern;
disposing the film at least one of in and around a mold;
injecting an injection molding material into a space defined by the mold and the film;
separating, from the mold, an injection molded product formed by curing the injection molding material; and
removing the film from the injection molded product.

20. The injection molding method according to claim 19, further comprising coating a surface of the injection molded product with a protective layer.
